(19) United States
(12) Patent Application Publication
(10) Pub. No.: US 2018/0287313 A1
(43) Pub. Date: Oct. 4, 2018

(54) ELECTRICAL APPLIANCE PLUG STRUCTURE

(71) Applicant: CHUNG-HSIN YU, Taichung (TW)

(72) Inventor: CHUNG-HSIN YU, Taichung (TW)

(21) Appl. No.: 15/474,279

(22) Filed: Mar. 30, 2017

(51) Int. Cl. H01R 24/30; H01R 13/08

(52) U.S. Cl. CPC H01R 24/30; H01R 2103/00; H01R 13/08

(57) ABSTRACT

An electrical appliance plug structure includes a body and two metal pins. The body includes a through hole, an installation operating surface, a gap in communication with the through hole and the installation operating surface, and two contact surfaces adjacent to the gap and corresponding to each other. The body has a pressing position that causes the two contact surfaces to be in mutual contact and a loosened position that causes the two contact surfaces to be away from each other. The two metal pins are disposed at the installation operation surface and are respectively located at two sides of the gap. When the two metal pins are inserted into a socket, the body is located at the loosened position to outwardly abut against copper plates in the socket to conduct current. After use, a finger is inserted into the through hole to easily remove the plug.

### FIELD OF THE INVENTION

The present invention relates to a plug, and particularly to an electrical appliance plug structure.

### BACKGROUND OF THE INVENTION

A plug is a mobile connector that may be inserted into a corresponding socket to connect an electrical appliance to a power source and cause the electrical appliance become operable. Referring to FIG. 1A showing a connection of a common plug and socket, a plug 1 includes a body 2 and two metal pins 3. By inserting the plug 1 into a socket 4, copper plates 5 in the socket 4 may clamp the two metal pins 3 to stabilize the plug 1 and cause the two metal pins 3 to be electrically connected to the copper plates 5, so as to provide power.

However, when the socket 4 is used over an extended period of time or improperly disposed, as shown in FIG. 1B, the copper plates 5 therein may age and become loose. At this point, the copper plates 5 may fail to securely clamp the two metal pins 3, in a way that not only the plug 1 likely becomes disengaged but also the copper plates 5 can no longer be electrically connected to the two metal pins 3, hence easily incurring dangers. Thus, most users may bend the two metal pins 3 to a slightly crooked angle to allow the copper plates 5 to again clamp the metal pins 3 to achieve a normal current flow. However, the above method of bending the metal pins 3 to a slightly crooked angle may easily cause damages in the metal pins 3.

Further, to remove the plug 1 after the plug 1 is no longer to be used, the plug 1 may not be readily pulled out since the two metal pins 3 are clamped by the copper plates 5. Therefore, there is a need for a solution for allowing the two metal pins 3 to be in normal contact with the copper plates 5 and for facilitating the removal of the plug 1.

### SUMMARY OF THE INVENTION

It is a primary object of the present invention to solve the issue that metal pins of a plug cannot remain in normal contact with copper plates in a socket.

It is another object of the present invention to solve the issue that a plug cannot be readily pulled out.

To achieve the above objects, the present invention provides an electrical appliance plug structure including a body and two metal pins. The body includes a through hole, an installation operating surface, a gap in communication with the through hole and the installation operating surface, two contact surfaces adjacent to the gap and corresponding to each other. The body includes a pressing position that causes the two contact surfaces to be in mutual contact, and a loosened position that causes the two contact surfaces to be located away from each other. The two metal pins are disposed on the installation operating surface, and are respectively located at two sides of the gap.

In conclusion, the present invention provides following features.

1. By providing the through hole, after use, a finger is inserted into the through hole to easily pull out the plug.

2. Copper plates in a socket may become dislocated from an original position when the socket is improperly disposed or due to ageing of copper plates, in a way that the socket may become too tight or too loose. Thus, with the gap provided, when the socket is too tight, the body may be pressed to locate the body at the pressing position, so that the plug may be easily inserted. When the plug is inserted, the body is located at the loosened position, and the two metal pins are allowed to abut outwards against the copper plates to conduct current, hence preventing the issue that a current cannot be conducted due to a loose socket.

### BRIEF DESCRIPTION OF THE DRAWINGS

FIG. 1A and FIG. 1B are partial section schematic diagrams of operations of a prior art;

FIG. 2A and FIG. 2B are perspective schematic diagrams of operations according to a first embodiment of the present invention;

FIG. 3 is a top planar schematic diagram according to a second embodiment of the present invention;

FIG. 4 is a top planar schematic diagram according to a third embodiment of the present invention;

FIG. 5 is a front planar schematic diagram according to the third embodiment of the present invention; and

FIG. 6 is a top planar schematic diagram according to a fourth embodiment of the present invention.

### DETAILED DESCRIPTION OF THE PREFERRED EMBODIMENTS

Details and technical contents of the present invention are given with the accompanying drawings below.

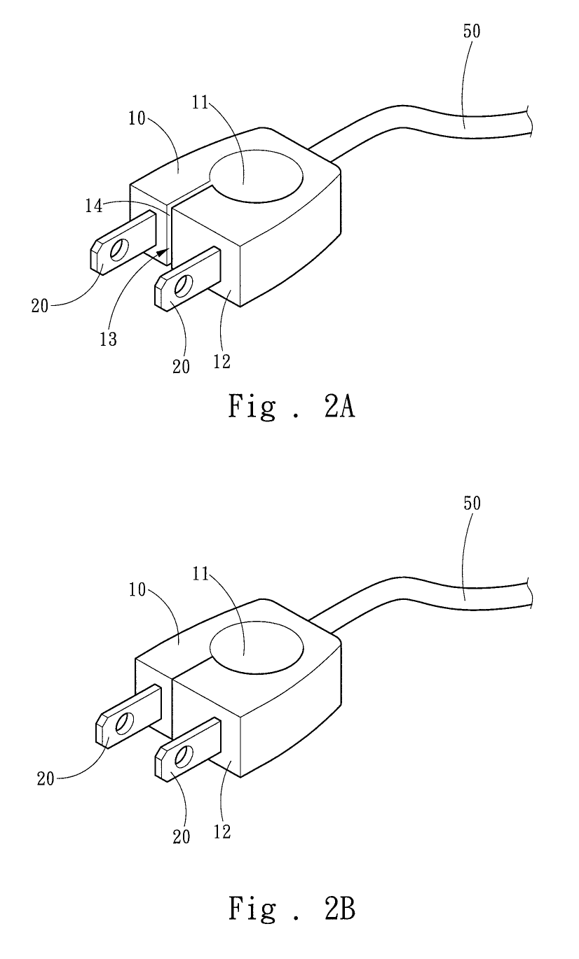

Referring to FIG. 2A and FIG. 2B, the present invention provides an electrical appliance plug structure, which includes a body 10 and two metal pins 20. The body 10 includes a through hole 11, an installation operating surface 12, a gap 13 in communication with the through hole 11 and the installation operating surface 12, and two contact surfaces 14 adjacent to the gap 13 and corresponding to each other. The two metal pins 20 are disposed on the installation operating surface 12 and are respectively located at two sides of the gap 13. Further, the body 10 includes a pressing position that causes the two contact surfaces 14 to be in mutual contact (shown in FIG. 2B), and a loosened position that causes the two contact surfaces 14 to be away from each other (shown in FIG. 2A).

Copper plates in a socket may become dislocated from an original position when the socket is improperly disposed or due to ageing of copper plates, in a way that the socket may become too tight or too loose. Thus, when the socket is too loose, with the gap 13 provided, when the two metal pins 20 are inserted, the body 10 is located at the loosened position using the elasticity of the body 10, such that the two metal pins 20 may outwardly abut against the copper plates to conduct current, thereby preventing the issue that current cannot be conducted due to the loose socket. When the socket is too tight and the two metal pins 20 cannot be easily inserted into the socket, the body 10 may be pressed to cause the two contact surfaces 14 to become mutually in contact to locate at the pressing position, and so the two metal pins 20 may be easily inserted. When the plug is to be removed after use, a finger is inserted into the through hole 11 to easily remove the plug.

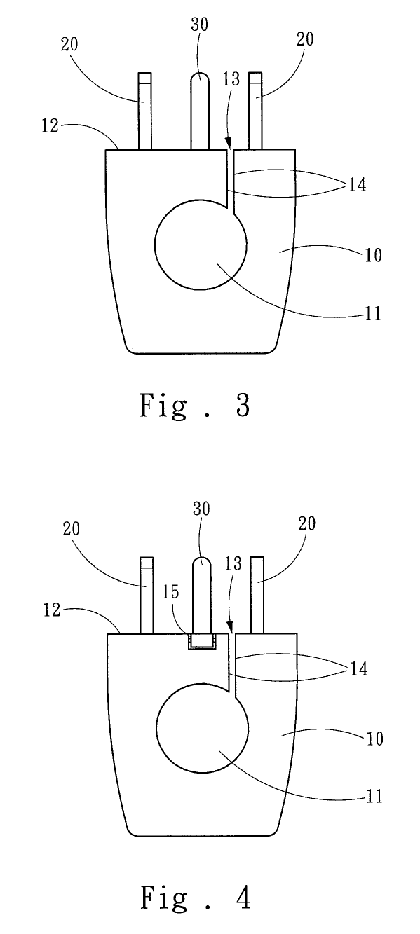

Referring to FIG. 3 to FIG. 5, the present invention further includes a ground pin 30, which is disposed at the installation operating surface 12. The ground pin 30 and the two metal pins 20 display a triangular arrangement. Compared to a design with only the two metal pins 20, such design has a larger contact area with the socket and may be more stably inserted in the socket for flexible applications. As shown in FIG. 4 and FIG. 5, a groove 15 is further provided on the installation operating surface 12, the ground pin 30 may be pivotally disposed in the groove 15, and the size of the ground pin 30 corresponds to the groove 15. To apply a two-hole socket, the ground pin 30 may be rotated and stored in the groove 15 for an adaptive application.

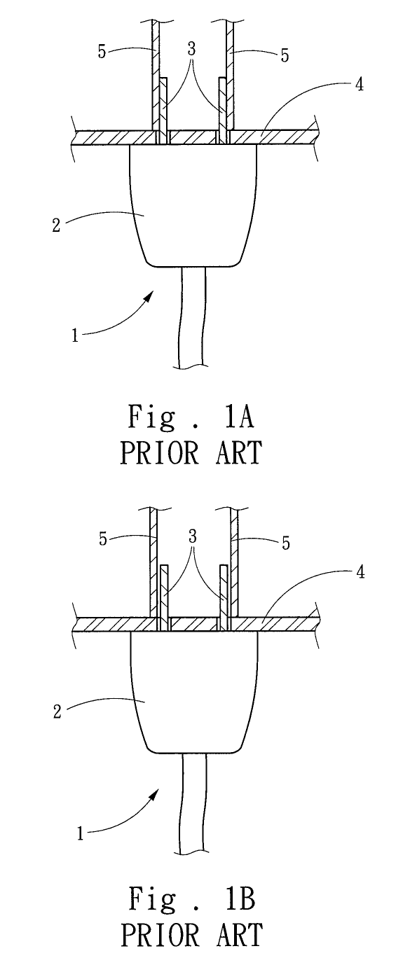

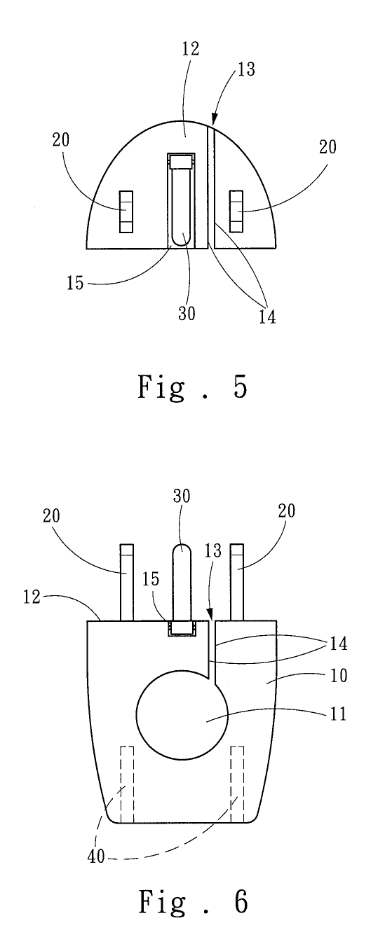

As shown in FIG. 6, the present invention may be directly used as a plug, or be used as an adaptor connector. Referring to FIG. 1 showing the present invention being applied directly as a plug, a wire 50 is disposed in the body 10, and the wire 50 is electrically connected to the two metal pins 20. Referring to FIG. 6 showing the present invention being applied as an adaptor connector, two inserting holes 40 are disposed on the body 10, and the two inserting holes 40 are respectively electrically connected to the two metal pins 20. In the embodiment, the two inserting holes 40 are disposed at one side of the body 10 away from the installation operating surface 12, for example. In conclusion, the present invention provides following features.

1. By providing the gap, when the two metal pins are inserted, the body is located at the loosened position to cause the two metal pins to outwardly abut against the copper plates to conduct current, thereby preventing the issue that current cannot be conducted due to a loose socket. Further, when the present invention is inserted, the body is pressed to locate at the pressing position, and the two metal pins may then be easily inserted.

2. With the through hole provided, when the plug is to be removed after use, a finger is inserted into the through hole to easily pull out the plug.

3. With the groove provided, the ground pin may be stored in the groove when not required, hence increasing application convenience.

What is claimed is:

1. An electrical appliance plug structure, comprising:
a body, comprising a through hole, an installation operating surface, a gap in communication with the through hole and the installation operating surface, and two contact surfaces adjacent to the gap and corresponding to each other, the body having a pressing position that causes the two contact surfaces to be in mutual contact and a loosened position that causes the two contact surfaces to be away from each other; and
two metal pins, disposed on the installation operating surface and respectively located at two sides of the gap.

2. The electrical appliance plug structure of claim 1, further comprising a ground pin disposed at the installation operating surface, the ground pin and the two metal pins displaying a triangular arrangement.

3. The electrical appliance plug structure of claim 1, further comprising a ground pin, the body further comprising a groove disposed at the installation operating surface, the ground pin pivotally installed in the groove, a size of the ground pin being corresponding to the groove.

4. The electrical appliance plug structure of claim 1, further comprising two inserting holes disposed at the body, the two inserting holes respectively electrically connected to the two metal pins.

5. The electrical appliance plug structure of claim 4, wherein the two inserting holes are disposed at one side of the body away from the installation operating surface.

6. The electrical appliance plug structure of claim 1, further comprising a wire disposed at the body, the wire electrically connected to the two metal pins.
